(19) United States
(12) Patent Application Publication
(10) Pub. No.: US 2019/0294526 A1
(43) Pub. Date: Sep. 26, 2019

(54) CODE DIFFERENCE FLAW SCANNER

(71) Applicant: Veracode, Inc., Burlington, MA (US)

(72) Inventor: Taylor Vandervoort Hayward, Melrose, MA (US)

(21) Appl. No.: 15/933,138

(22) Filed: Mar. 22, 2018

(51) Int. Cl. G06F 11/36; G06F 21/57

(52) U.S. Cl. CPC G06F 11/3664; G06F 11/3692; G06F 2221/033; G06F 11/3616; G06F 21/577

(57) ABSTRACT

When a code fragment is submitted for merger with a target program code, a software development tool determines the diffs between the code fragment and the target program code. The target program code may be a primary program code (e.g., main branch or trunk) or another branch or fork. The tool scans the diffs for security flaws and can also operate as a linter against the diffs. The tool identifies diffs that introduce security flaws or fail to comply with linter policy/rules in a user interface of the tool and can be programmed to disregard specified flaws to expedite review. Focusing the scanning on diffs avoids overwhelming peer reviewers with the technical debt and allows reviewers to fulfill the commitment to expedited review and the continuous development process.

### BACKGROUND

The disclosure generally relates to the field of information security, and more particularly to software development, installation, and management.

As with many endeavors, businesses that develop and sell software and/or provide a software-based service must make decisions that balance the pragmatism of running a business with the goal of high-quality for perfect customer experience. Producing high-quality program code that is free of any flaws and immaculately written (i.e., easy to read and/or conforming to best practices) is desirable, but the time it would take to ensure billions of lines of code is immaculate and free of any flaws would require an impractical investment in code review time by senior software engineers/developers. This would make the software/service unaffordable. This need for pragmatism in a hypercompetitive space of software development results in “technical debt.” Technical debt is a term that analogizes software development to financial debt. To meet a release deadline, developers may be forced to release program code with flaws, known or unknown. The program code is released under the assumption that the flaws will be found and corrected in later releases or updates. These flaws can be considered debt and the future work to correct these flaws, as well as code refactoring, is considered the accumulating interest. As time passes and flaws are not addressed (i.e., the debt is not reduced), the amount of time to correct is presumed to increase (i.e., the interest on the technical debt increases).

Continuous code review is a team-based commitment that attempts to address the balance between goals and pragmatism in code development. With continuous code review, a team of developers commits to speedily reviewing code commits. Some models for implementing this code review commitment include trunk-based development and pull requests. Although the details vary, these models generally involve a developer committing his/her program code to be merged into another collaborative instance of program code (e.g., trunk or branch). Before his/her program code is merged, another team member reviews and approves the program code for merger or returns the program code for modification. A software development tool for source code and version control facilitates the commitment and approval process.

### BRIEF DESCRIPTION OF THE DRAWINGS

Embodiments of the disclosure may be better understood by referencing the accompanying drawings.

FIG. 1 depicts an example software development tool that scans code diffs based on detection of a request to merge a code fragment with a target code.

FIG. 2 depicts an example graphical user interface rendered by a GUI engine based on code diffs and diff scanning.

FIG. 3 depicts a flowchart of example operations for determining whether diffs would introduce flaws into a program.

FIG. 4 depicts an example computer system with a code development tool that includes a diff scanner.

### DESCRIPTION

The description that follows includes example systems, methods, techniques, and program flows that embody aspects of the disclosure. However, it is understood that this disclosure may be practiced without these specific details. In other instances, well-known instruction instances, protocols, structures and techniques have not been shown in detail in order not to obfuscate the description.

Overview

A software development tool has been designed that scans “diffs” of a submitted code fragment and identifies security flaws introduced by the submitted code fragment. When a code fragment is submitted for merger with a target program code, the software development tool (“tool”) determines the differences (e.g., additions, edits, deletions) between the code fragment and the target program code. The target program code may be a primary program code (e.g., main branch or trunk) or another branch or fork. A code fragment may be a subroutine, one or more files of program code, or a line of program code. The tool scans the diffs for security flaws and can also operate as a linter against the diffs (e.g., scan the diffs for stylistic errors). The tool identifies diffs that introduce security flaws or fail to comply with linter policy/rules in a user interface of the tool and can be programmed to disregard specified flaws to expedite review. Focusing the scanning on diffs avoids overwhelming peer reviewers with the technical debt and allows reviewers to fulfill the commitment to expedited review and the continuous development process.

### Example Illustrations

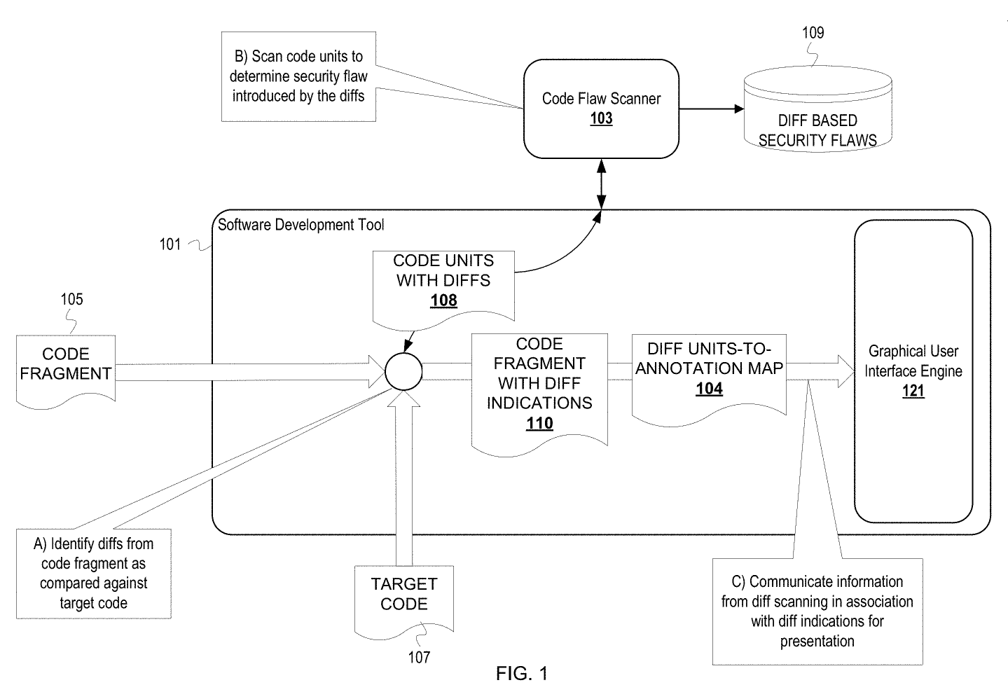

FIG. 1 depicts an example software development tool that scans code diffs based on detection of a request to merge a code fragment with a target code. A software development tool 101 allows for collaborative development of program code across developers. The software development tool 101 implements functionality to control versioning of program code. Disparate developers or development teams supply program code and program code changes into one or more repositories accessible by the software development tool 101. Before a code fragment can be merged with a target code unit, the software development tool 101 requires review and approval of the code fragment. This process of code review can be initiated by a request (e.g., pull request or merger request) initiated with the software development tool 101. The software development tool 101 can include its own scanning functionality, but FIG. 1 illustrates the software development tool 101 interfacing with a code flaw scanner 103. This code flaw scanner 103 can be an extension or plug-in for the software development tool 101, a service or program accessed through an application programming interface, etc. The software development tool 101 includes a graphical user interface (GUI) engine 121 to present the results of diff scanning to aid in efficient code review.

FIG. 1 is annotated with a series of letters A-C. These letters represent stages of operations. Although these stages are ordered for this example, the stages illustrate one example to aid in understanding this disclosure and should not be used to limit the claims. Subject matter falling within the scope of the claims can vary with respect to the order and some of the operations.

At a stage A, the software development tool 101 identifies diffs between a code fragment 105 and a target code unit 107. The software development tool 101 can include diff identifying functionality or invoke a separate utility to identify the diffs. The identification of diffs can be triggered in response to a request to merge the code fragment 105 into or with the target code unit 107. The software development tool 101 generates a file 108 that indicates the code units of the code fragment 105 that are different than the target code 107. The code units with diffs in the file 108 are at a granularity than can be scanned by the code flaw scanner 103. This granularity is a line of code in this illustration but can be configured in the software development tool 101 differently (e.g., n lines of code or a subroutine). The software development tool 101 passes the file 108 to the code flaw scanner 103 for scanning.

At stage B, the code flaw scanner scans the code units in the file 108 to determine whether the diffs introduce a security flaw. The code flaw scanner 103 scans the code units of the file 108 based on a set of one or more diff-based security flaws policies in a repository 109. The diff-based security flaws policies indicate types of changes to program code that have been identified as introducing vulnerabilities into program code. For instance, a security flaw policy may indicate that adding a function call defined by a particular API introduces a vulnerability or that insertion of a text field into a form without corresponding program code to verify input into the text field is not malicious code injection. In addition to scanning the changes to determine whether those changes introduce vulnerabilities, the code flaw scanner 103 can also scan the code fragment 105 to ascertain whether the code fragment 105 includes vulnerabilities. This can be considered an abbreviated scan in addition to the scan of changes or “diff scan” because the code flaw scanner 103 would be scanning code that already exists in the target code unit 107 but is not all of the target code unit 107.

Based on the diff scanning, the code flaw scanner 103 returns an indication of security vulnerabilities introduced by the diffs in association with the diffs. For example, the code flaw scanner 103 can return a data structure of file that identifies the code units by line number along with the corresponding security vulnerability introduced by each code unit. With this information, the security development tool 101 generates a map 104. The map 104 is a mapping of the code units identified as diffs (i.e., code units with changes) to annotations that indicate the security vulnerabilities detected by the code flaw scanner 103.

At stage C, the software development tool 101 communicates the information from the diff scanning and the indication of diffs to the GUI engine 121. The software development tool 101 passes a structure 110 that includes the code fragment 105 with indications of the diffs. The indications of the diffs can be values indicating a type of change (e.g., insertion or deletion) associated with line numbers or in a field associated with the field containing the corresponding code unit of the code fragment 105. The software development tool 101 also passes the map 104 to the GUI engine 121. Although this illustration describes a separation of the information, embodiments can generate and maintain the information of diffs and corresponding diff scanning results and as a single structure or as structures that reference each other. The GUI engine 121 uses the communicated information to render a user interface that allows a reviewer to determine the vulnerabilities, if any, introduced by the changes.

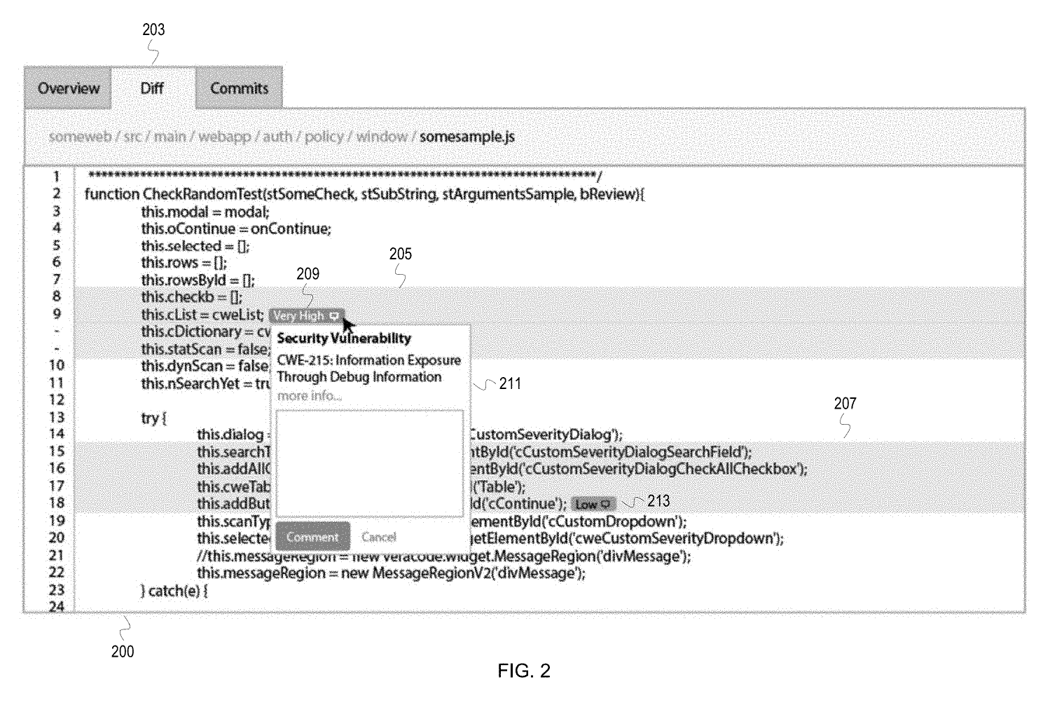

FIG. 2 depicts an example graphical user interface rendered by a GUI engine based on code diffs and diff scanning. A GUI engine renders a GUI instance 200 based on program code diffs and diff scanning results passed to the GUI engine. The GUI instance 200 includes a set of tabs, one of which is a “Diff” tab 203. The Diff tab 203 is the active tab in the GUI instance 200. The Diff tab 203 presents a code fragment or a code chunk of a code fragment that includes a function “CheckRandomTest.” The diffs are indicated in the GUI instance 200 with grey shaded areas 205, 207. The shaded area 205 indicates that lines 8-9 are being added and that lines of code between lines 9 and 10 are being removed. In addition to the shading, the GUI instance 200 indicates the removal with dashes in place of line numbers. The shaded area 209 indicates that lines 15-18 are being added. The code line 18 within the area 207 includes a vulnerability annotation 213. The annotation 213 indicates a “Low” security vulnerability introduced by the line 18 as detected by the diff scanning. The code line 9 within the area 205 includes a vulnerability annotation 209. The annotation 209 indicates a “Very High” security vulnerability introduced by the code in line 9 as detected by the diff scanning. The annotation 209 has been expanded to a comment box 211 that specifies the security vulnerability as “Information Exposure Through Debug Information.” The comment box 211 allows a reviewer to comment on the security vulnerability indicated by the annotation 209. This example illustration shows that a reviewer can efficiently review vulnerabilities of a code fragment with 24 lines of code before merger of the code fragment based on diff scanning. If the target code is millions of lines code with tech debt numbering in the thousands, the efficiency of reviewing the vulnerabilities introduced by the diff scan becomes substantial.

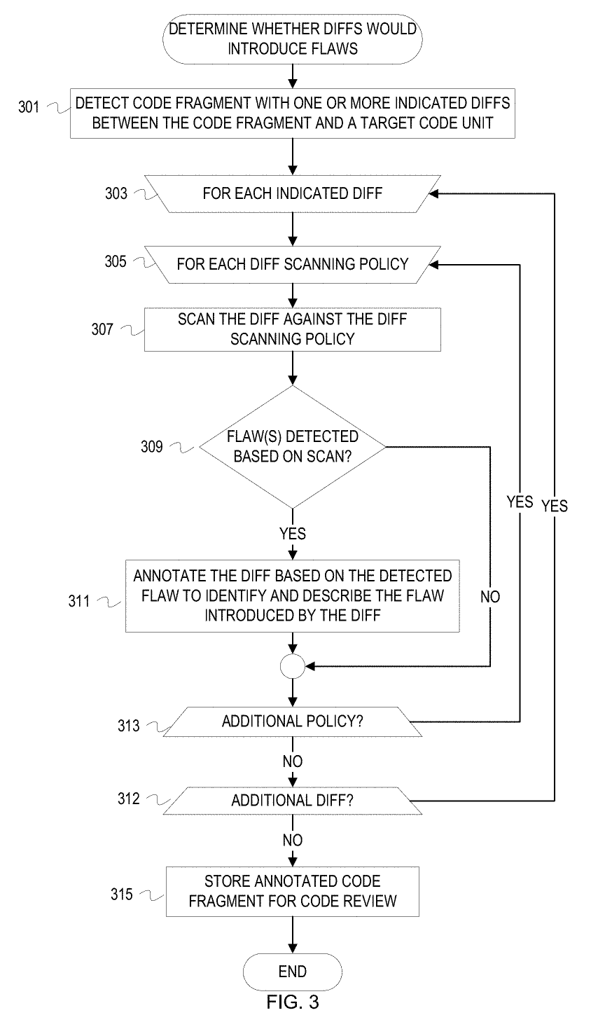

FIG. 3 depicts a flowchart of example operations for determining whether diffs would introduce flaws into a program. FIG. 3 will be described with reference to a “scanner” performing the example operations. The description of FIG. 3 uses “scanner” as shorthand for program code that scans diffs against one or more policies to determine flaws. Examples of flaws include security vulnerabilities and code lint. Assuming diff granularity at line level, scanning involves evaluating a line of code against rules and/or signatures indicated in the one or more policies.

After a software development tool determines diffs between a submitted code fragment and a target code unit, a scanner detects the code fragment with the determined diffs (301). The scanner can be invoked with a reference to the code fragment and a reference to the diffs, assuming the code fragment and diffs are indicated in different structures or files. The scanner can be invoked or receive a request that indicates a reference to a single file or structure that includes the code fragment and determined diffs. For instance, the scanner can be invoked with an argument that is a pointer to a data structure that associates indexes into a structured code fragment (e.g., the code fragment with line numbers) with codes or values that indicate diff type (e.g., insertion, deletion, edit).

With the determined diffs, the scanner iterates over the diffs (303) and scanning policies (305) to determine whether any of the determined diffs will introduce a flaw into the target code unit. In these example operations, the scanner evaluates each diff against the one or more policies being enforced by the software development tool. The description of FIG. 3 will refer to a diff of a current iteration a current diff and a policy of the current iteration as a current policy. The scanner scans the current diff against the current scanning policy (307). For instance, the scanner evaluates a code line of the code fragment indicated as being a diff against each scanning policy. The scanner may evaluate the diff against a security policy first and then a lint policy second. Each policy includes one or more rules or signatures to detect a flaw. The security policy can be organized according to various implementations. As an example, a security policy may organize the evaluation rules by diff type. If the security policy organizes rules by diff type, the scanner can determine a type of a current diff and then load or access the flaw rules for that diff type. The security policy, for instance, can indicate code attributes (e.g., input fields) that must be evaluated against a flaw rule (e.g., being passed to validating code that validates input submitted into the input field does not include code injection keywords). For a deletion, the security policy can ensure that a diff does not include cleansing code. The security policy may have code signatures of flaws in addition or instead of the flaw rules. To scan a diff, the scanner may go beyond the cliff. As in the example of the addition of an input text field, the scanner can evaluate the code fragment to determine whether the code fragment includes a reference to program code in the target code unit that sanitizes input submitted into an input text field.

The scanner will determine whether the scanning detected one or more flaws (311). If the diff scanning did not detect a flaw, then the scanner proceeds to evaluate the diff against the next policy, if any (313). If the diff scanning detected a flaw, then the scanner annotates the diff based on the detected flaw (311). The annotation identifies the flaw that would be introduced by the diff and describes the vulnerability. For instance, the scanner may add annotation data that identifies the flaw by type (e.g., code lint) and a description of the flaw (e.g., variable name does not conform to defined naming convention in flaw policy).

If there are no other policies to evaluates against the current diff, then the scanner proceeds to scan the next diff (312). If the determined diffs have been scanned, then the scanner stores the annotated code fragment for code review (315). The annotations can be a separate structured with entries referenced by entries of the code fragment.

The flowcharts are provided to aid in understanding the illustrations and are not to be used to limit scope of the claims. The flowcharts depict example operations that can vary within the scope of the claims. Additional operations may be performed; fewer operations may be performed; the operations may be performed in parallel; and the operations may be performed in a different order. For example, the iterating operations depicted in FIG. 3 can be reversed or done in parallel. An embodiment can evaluate all diffs against each policy (i.e., the scanning policy selection loop contains the loop iterating over the diffs). In addition, the policies can be evaluated in parallel. It will be understood that each block of the flowchart illustrations and/or block diagrams, and combinations of blocks in the flowchart illustrations and/or block diagrams, can be implemented by program code. The program code may be provided to a processor of a general purpose computer, special purpose computer, or other programmable machine or apparatus.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality presented as individual modules/units in the example illustrations can be organized differently in accordance with any one of platform (operating system and/or hardware), application ecosystem, interfaces, programmer preferences, programming language, administrator preferences, etc.

Any combination of one or more machine-readable medium(s) may be utilized. The machine-readable medium may be a machine-readable signal medium or a machine-readable storage medium. A machine-readable storage medium may be, for example, but not limited to, a system, apparatus, or device, that employs any one of or combination of electronic, magnetic, optical, electromagnetic, infrared, or semiconductor technology to store program code. More specific examples (a non-exhaustive list) of the machine-readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine-readable storage medium may be any tangible medium that can contain, or store a program for use by or in connection with an instruction execution system, apparatus, or device. A machine-readable storage medium is not a machine-readable signal medium.

A machine-readable signal medium may include a propagated data signal with machine-readable program code embodied therein, for example, in baseband or as part of a carrier wave. Such a propagated signal may take any of a variety of forms, including, but not limited to, electro-magnetic, optical, or any suitable combination thereof. A machine-readable signal medium may be any machine-readable medium that is not a machine-readable storage medium and that can communicate, propagate, or transport a program for use by or in connection with an instruction execution system, apparatus, or device.

Program code embodied on a machine-readable medium may be transmitted using any appropriate medium, including but not limited to wireless, wireline, optical fiber cable, RF, etc., or any suitable combination of the foregoing.

Computer program code for carrying out operations for aspects of the disclosure may be written in any combination of one or more programming languages, including an object oriented programming language such as the Java® programming language, C++ or the like; a dynamic programming language such as Python; a scripting language such as Perl programming language or PowerShell script language; and conventional procedural programming languages, such as the “C” programming language or similar programming languages. The program code may execute entirely on a stand-alone machine, may execute in a distributed manner across multiple machines, and may execute on one machine while providing results and or accepting input on another machine.

The program code/instructions may also be stored in a machine-readable medium that can direct a machine to function in a particular manner, such that the instructions stored in the machine-readable medium produce an article of manufacture including instructions which implement the function/act specified in the flowchart and/or block diagram block or blocks.

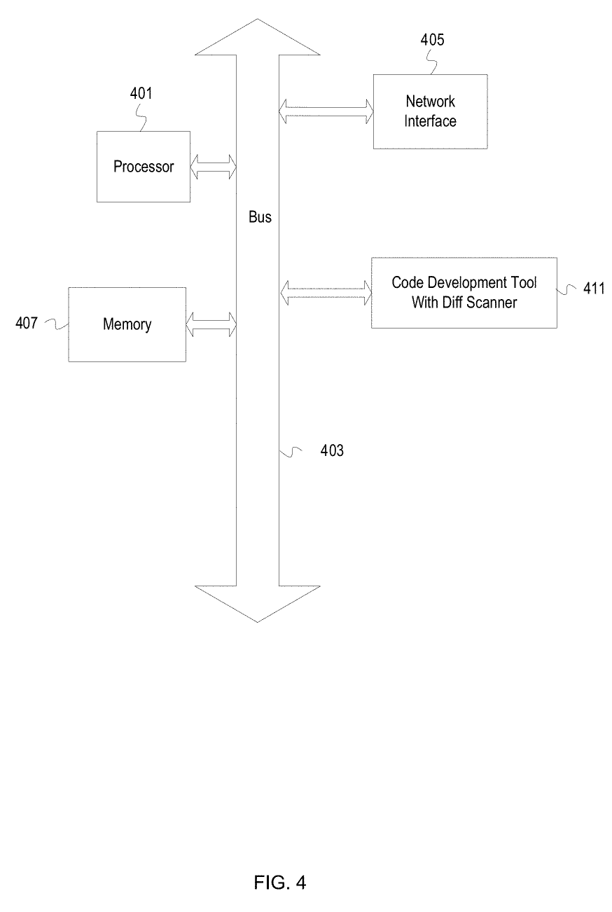

FIG. 4 depicts an example computer system with a code development tool that includes a diff scanner. The computer system includes a processor 401 (possibly including multiple processors, multiple cores, multiple nodes, and/or implementing multi-threading, etc.). The computer system includes memory 407. The memory 407 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable media. The computer system also includes a bus 403 (e.g., PCI, ISA, PCI-Express, HyperTransport® bus, InfiniBand® bus, NuBus, etc.) and a network interface 405 (e.g., a Fiber Channel interface, an Ethernet interface, an internet small computer system interface, SONET interface, wireless interface, etc.). The system also includes a code development tool 411. The code development tool 411 includes a diff scanner. The code development tool 411 determines diffs between a code fragment submitted to the code development tool 411 for merging with a target code unit (e.g., code branch or main trunk). The diff scanner scans the diffs, not the entire code fragment or the target code unit, to determine whether any of the diffs will introduce a flaw into the target code unit if the merging is carried out. Any one of the previously described functionalities may be partially (or entirely) implemented in hardware and/or on the processor 401. For example, the functionality may be implemented with an application specific integrated circuit, in logic implemented in the processor 401, in a co-processor on a peripheral device or card, etc. Further, realizations may include fewer or additional components not illustrated in FIG. 4 (e.g., video cards, audio cards, additional network interfaces, peripheral devices, etc.). The processor 401 and the network interface 405 are coupled to the bus 403. Although illustrated as being coupled to the bus 403, the memory 407 may be coupled to the processor 401.

While the aspects of the disclosure are described with reference to various implementations and exploitations, it will be understood that these aspects are illustrative and that the scope of the claims is not limited to them. In general, techniques for scanning code diffs to determine whether any introduce code flaws as described herein may be implemented with facilities consistent with any hardware system or hardware systems. Many variations, modifications, additions, and improvements are possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the disclosure. In general, structures and functionality presented as separate components in the example configurations may be implemented as a combined structure or component. Similarly, structures and functionality presented as a single component may be implemented as separate components. These and other variations, modifications, additions, and improvements may fall within the scope of the disclosure.

Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed.

What is claimed is:

1. A method comprising:
determining program code differences that would result from merging a code fragment with a target code unit;
based on indications of the program code differences, scanning the program code differences to detect flaws that may be introduced into the target code unit if merged with the code fragment;
for each flaw detected from the scanning, annotating a corresponding one of the program code differences with an indication of the flaw and a description of the flaw; and
updating a graphical user interface of a software development tool to indicate the differences and to indicate the annotations in association with corresponding ones of the differences.

2. The method of claim 1, wherein scanning the program code differences comprises evaluating the program code differences against a security vulnerability policy to detect security vulnerabilities introduced by the program code differences.

3. The method of claim 2, wherein evaluating the program code differences against a security vulnerability policy comprises evaluating the program code differences by difference type.

4. The method of claim 2, wherein the security vulnerability policy comprises at least one of security vulnerability signatures and attributes of security vulnerabilities.

5. The method of claim 2, wherein scanning the program code differences also comprises evaluating the program code differences against a code formatting policy.

6. The method of claim 1, wherein the indications of program code differences between the code fragment and the target code unit comprise at least one of an identifier of a code unit that would be added to the target code unit if merged with the code fragment, an identifier of a code unit in the target code unit that would be deleted from the target code unit if merged with the code fragment, an identifier of a code unit in the target code unit that would be modified if the code fragment is merged with the target code unit.

7. The method of claim 6, wherein a code unit is a line of program code and the target code unit is one of a different branch than the code fragment, a main trunk of program code, and a different version of program code than the code fragment.

8. The method of claim 1 further comprising invoking a vulnerability scanner from a software development tool based on detection by the software development tool of a request to merge the code fragment with the target code unit, wherein the software development tool invokes the vulnerability scanner to perform the scanning.

9. The method of claim 1, wherein annotating a program code difference for each flaw detected for the program code difference comprises generating a mapping from an indication of the program code difference to each of the flaws detected as introduced by the program code difference.

10. One or more non-transitory machine-readable media comprising program code for code diff scanning, the program code comprising instructions to:
determine program code differences that would result from merging a code fragment with a target code unit;
based on indications of the program code differences, scan the program code differences to detect flaws that may be introduced into the target code unit if merged with the code fragment;
for each flaw detected from the scanning, annotate a corresponding one of the program code differences with an indication of the flaw and a description of the flaw; and
update a graphical user interface of a software development tool to indicate the differences and to indicate the annotations in association with corresponding ones of the differences.

11. The non-transitory machine-readable media of claim 10, wherein the instructions to scan the program code differences comprise instructions to evaluate the program code differences against a security vulnerability policy to detect security vulnerabilities introduced by the program code differences.

12. The non-transitory machine-readable media of claim 11, wherein the instructions to evaluate the program code differences against a security vulnerability policy comprises evaluating the program code differences by difference type.

13. The non-transitory machine-readable media of claim 11, wherein the security vulnerability policy comprises at least one of security vulnerability signatures and attributes of security vulnerabilities.

14. The non-transitory machine-readable media of claim 11, wherein the instructions to scan the program code differences also comprise instructions to evaluate the program code differences against a code formatting policy.

15. An apparatus comprising:
a processor; and
a machine-readable medium having program code executable by the processor to cause the apparatus to,
determine program code differences that would result from merging a code fragment with a target code unit;
based on indications of the program code differences, scan the program code differences to detect flaws that may be introduced into the target code unit if merged with the code fragment;
for each flaw detected from the scanning, annotate a corresponding one of the program code differences with an indication of the flaw and a description of the flaw; and
update a graphical user interface of a software development tool to indicate the differences and to indicate the annotations in association with corresponding ones of the differences.

16. The apparatus of claim 15, wherein the program code to scan the program code differences comprises program code executable by the processor to cause the apparatus to evaluate the program code differences against a security vulnerability policy to detect security vulnerabilities introduced by the program code differences.

17. The apparatus of claim 16, wherein the program code to evaluate the program code differences against a security vulnerability policy comprises program code executable by the processor to cause the apparatus to evaluate the program code differences by difference type.

18. The apparatus of claim 16, wherein the security vulnerability policy comprises at least one of security vulnerability signatures and attributes of security vulnerabilities.

19. The apparatus of claim 16, wherein the program code to scan the program code differences also comprises program code executable by the processor to cause the apparatus to evaluate the program code differences against a code formatting policy.

20. The apparatus of claim 15, wherein the program code to annotate a program code difference for each flaw detected for the program code difference comprises program code executable by the processor to cause the apparatus to generate a mapping from an indication of the program code difference to each of the flaws detected as introduced by the program code difference.
